(19) United States
(12) Patent Application Publication
(10) Pub. No.: US 2012/0297792 A1
(43) Pub. Date: Nov. 29, 2012

(54) THERMOCOUPLE WELL FOR A TURBOMACHINE

(75) Inventors: Daniel Jackson Dillard, Greenville, SC (US); Gregory Thomas Foster, Greer, SC (US); George Martin Gilchrist, III, Greenville, SC (US)

(73) Assignee: GENERAL ELECTRIC COMPANY, Schenectady, NY (US)

(21) Appl. No.: 13/117,199

(22) Filed: May 27, 2011

(51) Int. Cl. F02C 7/20; B23P 15/04

(52) U.S. Cl. 60/796; 29/889.2

(57) ABSTRACT

A turbomachine includes a nozzle. The nozzle includes an end portion and an airfoil portion. A diaphragm is mounted to the end portion of the nozzle in a wheel space portion of the turbomachine. The diaphragm includes an external surface and an internal surface. The diaphragm also includes at least one thermocouple well receiving portion formed in one of the external surface and the internal surface. A thermocouple well is mounted in the at least one thermocouple well receiving portion. The thermocouple well includes a first end exposed to the wheel space portion of the turbomachine and a second end exposed at the internal surface of the diaphragm.

### BACKGROUND OF THE INVENTION

The subject matter disclosed herein relates to the art of turbomachines and, more particularly, to a thermocouple well for a turbomachine.

In a gas turbomachine, air flows in a wheel space between a stationary component (nozzle) and a rotating wheel. Temperature of the air flow is monitored to detect whether any combustion gases are entering the wheel space. Temperature is monitored using thermocouples arranged in thermocouple wells installed into a diaphragm portion of the nozzle. A typical thermocouple well includes a tip section, a threaded section that is mounted to the diaphragm, and an opening that receives a guide tube and thermocouple wire. Conventional turbomachine designs require that the diaphragm be installed to the nozzle prior to installation of the thermocouple well. After installation to the nozzle, the threaded section of the thermocouple well is secured in a threaded opening formed in an internal surface of the diaphragm. Once mounted, the guide tube is fitted into the opening of the thermocouple well. At this point, the thermocouple wire is fed through the guide tube, and passed up to the tip section. Accordingly, conventional diaphragms must be formed to have a certain minimum radial height to allow for installation of the thermocouple.

### BRIEF DESCRIPTION OF THE INVENTION

According to one aspect of the invention, a turbomachine includes a nozzle having an end portion and an airfoil portion. A diaphragm is mounted to the end portion of the nozzle in a wheel space portion of the turbomachine. The diaphragm includes an external surface and an internal surface. The diaphragm also includes at least one thermocouple well receiving portion formed in one of the internal surface and the external surface. A thermocouple well is mounted in the at least one thermocouple well receiving portion. The thermocouple well includes a first end exposed to the wheel space portion of the turbomachine and a second end exposed at the internal surface of the diaphragm.

According to another aspect of the invention, a method of mounting a thermocouple well in a turbomachine includes mounting a thermocouple well in one of an external surface and an internal surface of a diaphragm, securing the diaphragm to first and second diaphragm mounting members extending from a second end of a nozzle, positioning an end section of a thermocouple guide tube in the nozzle adjacent the thermocouple well. The thermocouple guide tube is spaced from the thermocouple well.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is partial cross-sectional view of a turbomachine nozzle and diaphragm including a thermocouple well in accordance with an exemplary embodiment;

FIG. 2 is a partial cross-sectional view of the thermocouple well mounted to an exterior surface of a wall of the diaphragm of FIG. 1;

FIG. 3 is a lower left front perspective view of the thermocouple well in accordance with the exemplary embodiment; and

FIG. 4 is a lower right rear perspective view of the thermocouple well of FIG. 3.

The detailed description explains embodiments of the invention, together with advantages and features, by way of example with reference to the drawings.

### DETAILED DESCRIPTION OF THE INVENTION

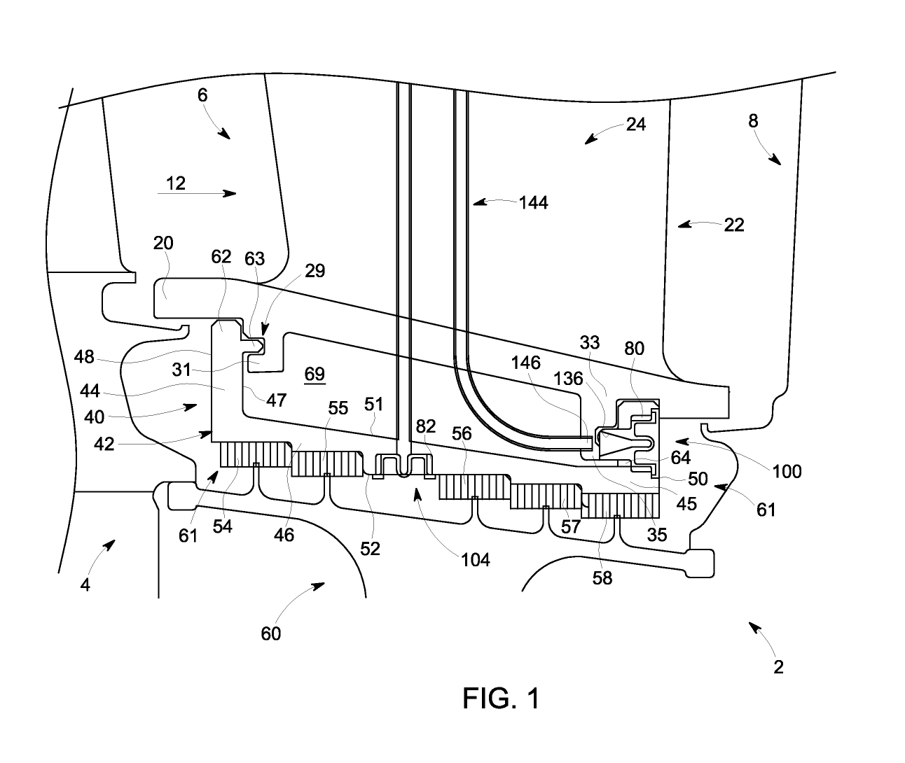

A turbomachine in accordance with an exemplary embodiment is indicated generally at 2 in FIG. 1. Turbomachine 2 includes a turbomachine stage 4 having a stationary nozzle 6 positioned upstream from a blade member 8 in a hot gas path 12. Nozzle 6 includes a first end portion (not shown) secured to a casing portion (also not shown) of turbomachine 2. The first end portion extends to a second end portion 20 through an intermediate portion 22 that defines an airfoil 24. Second end portion 20 includes a first diaphragm mounting member 29 having a first hook portion 31 and a second, opposing diaphragm mounting member 33 having a second hook portion 35. A diaphragm 40 is mounted to second end portion 20 of nozzle 6 through first and second diaphragm mounting member 29 and 33.

Diaphragm 40 includes a body 42 having a first or upstream wall 44, a second or down stream wall 45, and a base wall 46. Upstream wall 44 includes an interior surface 47 and an exterior surface 48, downstream wall 45 includes an interior surface 49 and an exterior surface 50, and base wall 46 includes an interior surface 51 and an exterior surface 52. Diaphragm 40 also includes a plurality of seal members 54-58 provided on exterior surface 52 of base wall 46. Seal members 54-58 create a seal between diaphragm 40 and a rotor wheel 60. Seal members 54-58 are arranged to substantially prevent combustion gases in hot gas path 12 from passing into a wheel space 61. Diaphragm 40 is also shown to include a first nozzle mounting member 62 having a first hook element 63 and a second nozzle mounting member 64 that includes a second hook element 65. Nozzle mounting members 62 and 64 engage with diaphragm mounting members 29 and 33 to secure diaphragm 40 to nozzle 6 creating a nozzle cavity 69. Diaphragm 40 is further shown to include a first thermocouple well receiving portion 80 formed in exterior surface 50 of downstream wall 45, and a second thermocouple well receiving portion 82 formed in exterior surface 52 of base wall 46.

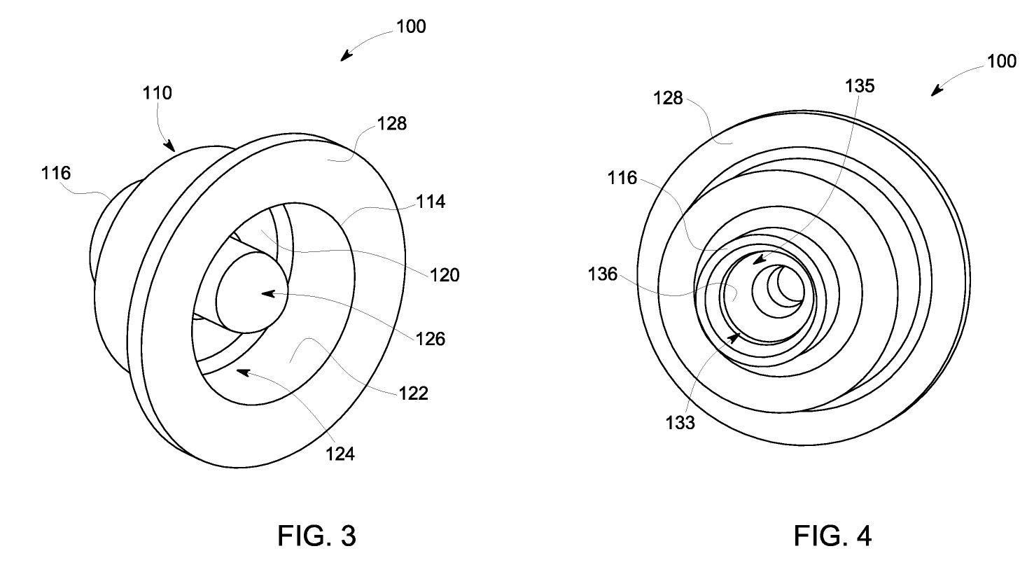

As will be discussed more fully below, diaphragm 40 supports sensors for monitoring gas temperature in wheel space 61 to provide an indication of any combustion gases passing from hot gas path 12. In accordance with the exemplary embodiment, diaphragm 40 includes a first thermocouple well 100 mounted in first thermocouple well receiving portion 80 and a second thermocouple well 104 mounted in second thermocouple well receiving portion 82. As each thermocouple well is substantially similar, a detailed description will follow with reference to FIGS. 3-4 describing first thermocouple well 100 with an understanding the second thermocouple well 104 includes corresponding structure.

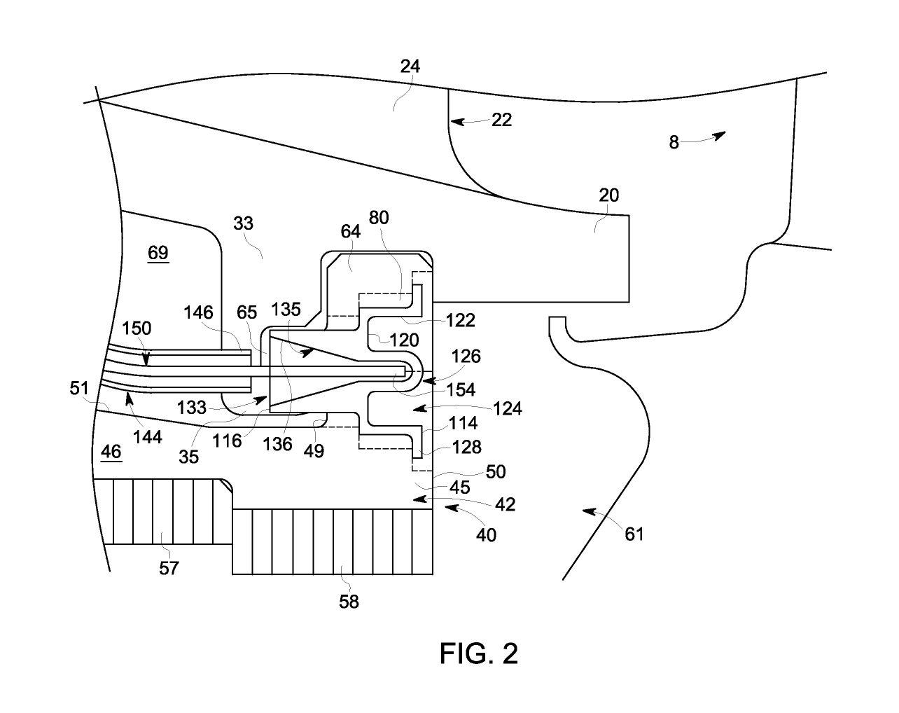

As best shown in FIG. 2, thermocouple well 100 includes a body portion 110 having a first end 114 that extends to a second end 116. First end 114 includes a base wall portion 120 and an inner wall portion 122 that define a recess 124. A tip portion 126 extends from base wall portion 120 into recess 124. First end 114 is also shown to include an annular flange 128 that nests within exterior surface 50 of downstream wall 45. When diaphragm 40 is installed to nozzle 6, a portion of flange member 128 extends into second end portion 20. As such, thermocouple well 100 enables diaphragm 40 to have a lower profile than that achieved by previous diaphragm designs. Second end 116 includes a thermocouple receiving portion 133. As will be detailed more fully below, thermocouple receiving portion 133 includes a tapered cross-section 135 that establishes a conical surface 136.

In further accordance with the exemplary embodiment, turbomachine 2 includes a thermocouple guide tube 144. As shown, thermocouple guide tube 144 passes through a cavity (not separately labeled) formed in nozzle 6 toward thermocouple well 100. More specifically, thermocouple guide tube 144 extends from a first end portion (not shown) to a second end section 146 that is positioned circumferentially adjacent diaphragm mounting member 33 and spaced from second end 116 of thermocouple well 100. With this arrangement, a thermocouple wire 150 is passed through thermocouple guide tube 144 toward thermocouple well 100. A terminal end portion 154 of thermocouple wire 150 nests within tip portion 126.

At this point it should be understood, that the thermocouple well in accordance with the exemplary embodiment is installed into an exterior surface of the diaphragm. In this manner, the thermocouple well can be installed prior to mounting the diaphragm. However, it should also be understood that the thermocouple well could be installed in an internal surface of the diaphragm prior to mounting. Installing the thermocouple well prior to mounting the diaphragm allows the diaphragm cavity to be much smaller as there is no longer a need to provide ample space for access to tools and the like. Accordingly, the diaphragm can be designed to have a much smaller profile. The smaller profile allows engineers to decrease an overall size of the turbomachine. The smaller profile of the diaphragm also enables a reduced wheel space volume. The reduced wheel space volume requires less purge flow to prevent ingestion of combustion gases.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A turbomachine comprising:
a nozzle including an end portion and an airfoil portion;
a diaphragm mounted to the end portion of the nozzle in a wheel space portion of the turbomachine, the diaphragm including an external surface and an internal surface, the diaphragm including at least one thermocouple well receiving portion formed in one of the internal surface and the external surface; and
a thermocouple well mounted in the at least one thermocouple well receiving portion, the thermocouple well including a first end exposed to the wheel space portion of the turbomachine and a second end exposed at the internal surface of the diaphragm.

2. The turbomachine according to claim 1, wherein the thermocouple well includes a body portion including a base wall portion, an inner wall portion that defines a recess, and a tip portion that extends into the recess from the base wall portion.

3. The turbomachine according to claim 2, wherein the thermocouple well includes a flange member that extends perpendicularly outward from the first end.

4. The turbomachine according to claim 2, wherein the thermocouple well includes a thermocouple receiving portion at the second end, the thermocouple receiving portion extending from the second end into the tip portion.

5. The turbomachine according to claim 4, wherein the thermocouple receiving portion includes a tapered cross-section.

6. The turbomachine according to claim 5, wherein the tapered cross-section defines a conical surface.

7. The turbomachine according to claim 2, further comprising: a thermocouple guide tube extending through the nozzle toward the diaphragm, the thermocouple guide tube including an end section mounted to the nozzle adjacent the thermocouple well receiving portion, the end portion of the thermocouple guide tube being spaced from the second end of the thermocouple well.

8. The turbomachine according to claim 7, wherein the nozzle includes a diaphragm mounting member, the thermocouple guide tube being positioned circumferentially adjacent the diaphragm mounting member.

9. The turbomachine according to claim 7, further comprising: a thermocouple wire passing through the thermocouple guide tube into the tip portion of the thermocouple well.

10. The turbomachine according to claim 1, wherein at least a portion of the thermocouple well extends into the end portion of the nozzle.

11. The turbomachine according to claim 1, wherein the diaphragm includes an upstream side wall, a downstream side wall, and a base wall that joins the upstream and downstream side walls, the thermocouple well being provided in one of the upstream side wall, the downstream side wall and the base wall.

12. The turbomachine according to claim 11, further comprising: another thermocouple well provided in another one of the upstream side wall, downstream side wall, and the base wall of the diaphragm.

13. The turbomachine according to claim 12, wherein the thermocouple well is mounted in the downstream side wall of the diaphragm and the another thermocouple well is mounted in the base wall of the diaphragm.

14. A method of mounting a thermocouple well in a turbomachine, the method comprising:
mounting a thermocouple well in one of an external surface and an internal surface of a diaphragm;
securing the diaphragm to first and second diaphragm mounting members extending from a second end of a nozzle; and
positioning an end section of a thermocouple guide tube adjacent the thermocouple well, the thermocouple guide tube being spaced from the thermocouple well.

15. The method of claim 14, further comprising: passing a thermocouple wire through the thermocouple guide tube into a tip portion of the thermocouple well.

16. The method of claim 14, wherein securing the diaphragm to the first and second diaphragm members includes covering a portion of the thermocouple well with a portion of the nozzle.

17. The method of claim 14, further comprising: mounting another thermocouple well in another of the external surface and internal surface of the diaphragm.

18. The method of claim 14, wherein mounting the thermocouple well comprises mounting the thermocouple well in an exterior surface of the diaphragm adjacent a rotor wheel member of the turbomachine.

19. The method of claim 14, wherein mounting the thermocouple well comprises mounting the thermocouple well in an exterior surface of the diaphragm adjacent a blade member of the turbomachine.

20. The method of claim 14, wherein positioning the end section of the thermocouple guide tube in the nozzle includes positioning the end section of the thermocouple guide tube circumferentially adjacent a diaphragm mounting member.
